(19) United States
(12) Patent Application Publication
(10) Pub. No.: US 2015/0281371 A1
(43) Pub. Date: Oct. 1, 2015

(54) APPARATUS, SYSTEM, AND METHOD FOR CONNECTING DEVICES

(71) Applicant: Conversant Intellectual Property Management Incorporated, Ottawa (CA)

(72) Inventor: Robert Anthony BACON, Frisco, TX (US)

(21) Appl. No.: 14/667,759

(22) Filed: Mar. 25, 2015

Related U.S. Application Data
(60) Provisional application No. 61/970,741, filed on Mar. 26, 2014.
(60) Provisional application No. 61/970,770, filed on Mar. 26, 2014.

(30) Foreign Application Priority Data
May 19, 2014 (GB) 1408820.7
May 19, 2014 (GB) 1408821.5

(51) Int. Cl. H04L 29/08

(52) U.S. Cl. CPC H04L 67/141; H04L 67/10

(57) ABSTRACT

In one embodiment, a method includes receiving availability information of a first user. The method also includes transmitting the availability information of the first user to a device through a communication network. In addition, the method includes receiving, from the device, contact information of a second user having availability overlap with the first user such that the first and second users have identified each other as desired communication contacts. The method further includes initiating, based at least on a portion of the received contact information, establishment of a connection between a device of the first user and a device of the second user.

### CROSS-REFERENCE TO RELATED APPLICATIONS

This patent application claims priority from, and incorporates by reference the entire disclosure of, U.S. Provisional Patent Application No. 61/970,741, filed Mar. 26, 2014 and U.S. Provisional Patent Application No. 61/970,770, filed Mar. 26, 2014. This patent application claims priority from, and incorporates by reference the entire disclosure of, U.K. Patent Application No. 1408821.5, filed May 19, 2014 and U.K. Patent Application No. 1408820.7, filed May 19, 2014.

### BACKGROUND

1. Technical Field

The present disclosure relates generally to communications networks and, more particularly but not by way of limitation, to apparatuses, systems, and methods for facilitating connections between devices.

2. History of Related Art

Existing technological and non-technological methods for finding and scheduling time to stay in touch with people are generally difficult and inefficient. Typically, significant amounts of time must be spent soliciting and reconciling availabilities for telephone conversations, videoconferences, and the like. Such complexity ultimately results in people failing to stay in touch with others who are important to them.

### SUMMARY

In one embodiment, a method includes receiving availability information of a first user. The method also includes transmitting the availability information of the first user to a device through a communication network. In addition, the method includes receiving, from the device, contact information of a second user having availability overlap with the first user such that the first and second users have identified each other as desired communication contacts. The method further includes initiating, based at least on a portion of the received contact information, establishment of a connection between a device of the first user and a device of the second user. The transmitting of the availability information of the first user, the receiving of the contact information of the second user, and the initiating of the establishment of the connection are performed automatically subsequent to receiving availability information of the first user.

In one embodiment, a method includes receiving availability information of a first user. The method further includes transmitting, through a communication network, the availability information of the first user to one or more devices associated with one or more users identified as one or more desired communication contacts of the first user. The method also includes receiving availability information for at least a portion of the one or more users from the one or more devices associated with the one or more users. In addition, the method includes identifying, based at least on a portion of the received availability information, an availability overlap between the first user and a second user such that the second user has identified the first user as a desired communication contact. Moreover, the method includes initiating establishment of a connection between a device of the first user and a device of the second user. Also, the transmitting of the availability information of the first user, the receiving of the availability information for at least a portion of the one or more users, the identifying of the availability overlap between the first user and the second user, and the initiating of the establishment of the connection are performed automatically subsequent to receiving the availability information of the first user.

In one embodiment, a method includes receiving availability information of a first user on a first device associated with the first user. The method further includes receiving availability information for a second user from a second device associated with the second user. In addition, the method includes identifying, based at least on a portion of the received availability information, an availability overlap between the first user and a second user such that the first and second users have identified each other as desired communication contacts. The method also includes transmitting, via the first device, availability information of the first user to the second device through a communication network. Also, the receiving availability information for the second user, identifying an availability overlap, and transmitting availability information are performed automatically subsequent to receiving availability information of the first user.

The above summary is not intended to represent each embodiment or every aspect of the present disclosure.

### BRIEF DESCRIPTION OF THE DRAWINGS

A more complete understanding of the disclosed method and apparatus may be obtained by reference to the following Detailed Description when taken in conjunction with the accompanying Drawings wherein:

FIG. 1 illustrates a communications system;

FIG. 2 illustrates an example of registration information;

FIG. 3A illustrates an example of a process for registering unregistered users and/or updating registration information for registered users;

FIG. 3B illustrates an example of a process for updating availability information;

FIG. 3C illustrates an example of a process for establishing and managing connections;

FIG. 4 illustrates an example of a process for duration management;

FIG. 5 illustrates an example of a process for providing conversation-guidance features;

FIG. 6 illustrates an example of a process for establishing and managing connections;

FIG. 7 illustrates an alternative communications system;

FIG. 8 illustrates an example of a process for establishing and managing connections in a peer-to-peer fashion; and

FIG. 9 illustrates an embodiment of a computer system.

### DETAILED DESCRIPTION OF ILLUSTRATIVE EMBODIMENTS

One way to approach communications scheduling is to allow users to form circles. Each member of a circle can indicate availability by updating a profile status to “available.” Thereafter, one member of the circle may determine whether any other members of the circle are available for communications (via instant messaging, for example). This approach has various disadvantages. For example, one member of the circle may update his profile status to “available” but only have in mind that he is available for instant messages as opposed to a phone call. Frequently, people multitask during meetings and other work throughout the day. Multitasking that includes instant messaging is relatively easy to do since pauses and delays with responses are acceptable and customary. Multitasking while having a phone conversation is difficult to implement and generally leads to one being rather disengaged during the phone call. Consequently, there is a large probability that the profile status of “available” does not mean “available for a phone call.”

Another disadvantage of the above-described communications-scheduling approach is that a member of the circle still has to initiate his communication with another member of the circle after making the effort to see who is available. The initiation may include confirming that the other circle member is available for a phone call, locating the other circle member's contact information, and making a call. This approach may be better than scheduling a future date, but in reality people still fail to take the initiative to make the connections that they really want to make. Further, it can include the extra step of confirming “phone availability.”

Yet another disadvantage of the above-described communications-scheduling approach is that it does not facilitate communication that is respectful of both parties' time availability. Keeping the communication to a predefined time period is left to the parties and can lead to an extension of the communication with consequences to one or both parties' subsequent schedules. Alternatively, if there is no extension of the communication, some or all parties may be left feeling bad about ending a good conversation and hurting another party's feelings. Further, this approach does not provide or suggest topics of conversation to the parties.

Another way to approach communications scheduling is to schedule conversations for later times when parties believe they will be available. Such largely passive, future-based approaches undesirably rely on people to proactively and correctly identify available contacts, to initiate conversations themselves, to manage the topics of conversation themselves, and to be diligent about communicating only for appropriate durations in view of each other's availabilities. Such approaches are unreliable when necessary parties unexpectedly continue or “run over” the durations of their conversations into time slots that have been scheduled for subsequent conversations with different parties. With life becoming more dynamic than ever, a future mutually agreeable date and time quickly becomes burdensome for one or both parties as new events take priority over phone calls with friends and family. Such approaches also miss opportunities to immediately connect people with each other during times when they have become unexpectedly and coincidentally available.

Additionally, while some people are willing to schedule conversations with their business contacts themselves, and others have the resources to delegate such activities to paid personal assistants, secretaries, and the like, the labor-intensiveness and distractions of the scheduling, and sometimes desires for privacy as well, undesirably discourage both do-it-yourselfers and delegators from scheduling communications with friends and family, with whom, as a result, they converse undesirably infrequently and haphazardly. Further, even when conversations with friends and family are scheduled, they are often scheduled for evenings or weekends, as scheduling them for times during work days is difficult. Such inattentiveness to friends, family, and others amounts to passive prioritizing, in which some individuals are inadvertently lowered and others are inadvertently elevated.

Particular embodiments described herein may allow connections to be spontaneously established among user devices, and consequently their corresponding users, with minimal user effort, without the need for advanced scheduling, at all times of the day, for appropriate durations, and with conversation guidance. Other embodiments may allow for a subset of the foregoing advantages.

Connection establishment can include, for example, automatically opening or engaging a physical or logical communications channel between a terminal of a communications system and at least one other component or at least one other terminal of the communications system. A connection can be representative, for example, of a connection between two or more user devices. In certain embodiments, the connection can enable voice communication, video communication, live/interactive text session, and/or other dialogue between the two or more user devices. In some cases, a conference connection can be an expanded connection formed from two or more other connections. The conference connection can be expanded, for example, by bridging the two or more other connections.

A user of a particular device can be, for example, a person who is presently operating that particular device (if that device is presently being operated), the last person who operated that particular device (if that device is not presently being operated), etc. In certain embodiments, relative to a communications system, users can be either registered users or unregistered users. A registered user can be, for example, a user who has input registration information. An unregistered user can be, for example, a user who has not input any registration information.

In certain embodiments, each registered user can provide registration information that identifies, for example, contacts with whom the user desires or is willing to connect. The contacts can specify, for example, other registered users of the system. In certain embodiments, contacts can be arranged, at the direction of registered users, into one or more groups and/or subgroups. A group can include, for example, a set of contacts who are related or associated such that the registered user who has these contacts may be interested in having a dialogue, when the registered user has an availability, with any one or more of these contacts based at least in part on the nature of the relationship or association. For example, groups can be established for family members, co-workers, college friends, professionals and potential clients, fellow hobbyists, etc.

In various embodiments, registered users can indicate availability information in a spontaneous, real-time fashion. For example, such availability information can specify a period of immediate availability and one or more contacts and/or groups of contacts to which that availability applies. In certain embodiments, a communications system and/or a user device can analyze registered users' contacts for purposes of intelligently connecting users who desire to be connected. For example, in response to real-time updates to contacts and/or availability information, availability overlaps can be identified among registered users who mutually desire a connection. In general, an availability overlap can be a coincidence or other sufficient compatibility between an availability of one registered user and an availability of at least one other registered user. In this fashion, the availability information and the registration information can be used to spontaneously establish connections.

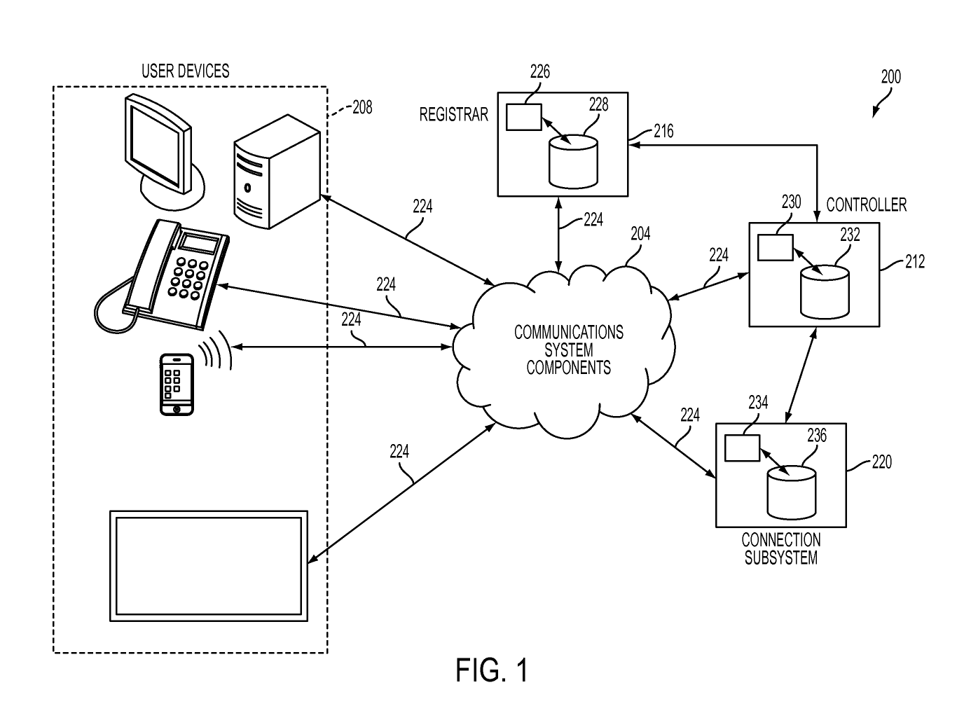

FIG. 1 illustrates a communications system 200 equipped to facilitate connections among users of devices. The communications system 200 includes communications system components 204, user devices 208, a controller 212, a registrar 216, and a suitable connection subsystem 220. For illustrative purposes, the controller 212, the registrar 216, and the connection subsystem 220 are shown separately. However, it should be appreciated that, in various embodiments, one or more of these systems can be combined. For example, the controller 212, the registrar 216, and/or the connection subsystem 220 can be combined into a single system that provides a common interface to the user devices 208.

The communications system components 204 are configured to communicably couple one or more of the user devices 208, the controller 212, the registrar 216, and the connection subsystem 220 over one or more communications channels 224. In a typical embodiment, the communications channels 224 may be implemented in wired form (for example, via coaxial cabling, fiber-optics, plain old telephone system (“POTS”) lines, one or more other suitable wired connections, or any suitable combination thereof), in wireless form (for example, Wi-Fi, 3G or 4G cellular transmissions, Bluetooth, one or more other suitable wireless connections, or any suitable combination thereof), in one or more broader technological groups, protocols, or standards (for example, Ethernet, voice over internet protocol (“VoIP”), one or more other suitable technological groups, protocols, or standards), or in any suitable combination thereof. To this end, in a typical embodiment, the communications system components 204 may include, wholly or partly, the Internet, an intranet, one or more other suitable wide area networks or local area networks, one or more suitable telephone networks, suitable digital equipment, suitable analog equipment, any other suitably configured wired or wireless communications equipment, or any suitable combination thereof.

One or more of the user devices 208 is operable to contribute to facilitations of connections as discussed in greater detail below. In a typical embodiment, each of the user devices 208 may be constructed to include, for example, one or more processing devices, one or more memory modules, and software that causes the processing devices to operate according to one or more of the disclosed embodiments. Each of the user devices 208 may be implemented, for example, in the form of a desktop computer loaded with suitable software, a laptop computer loaded with suitable software, a tablet computer loaded with suitable software, a mobile phone loaded with suitable software, a personal digital assistant (“PDA”) loaded with suitable software, a smart television loaded with suitable software, and/or any other suitably configured communications system terminal.

The controller 212 is operable to contribute to facilitations of connections as discussed in greater detail below. In a typical embodiment, the controller 212 may be constructed from, for example, one or more processing devices, one or more memory modules, and software that causes the processing device to operate according to one or more of the disclosed embodiments. For example, as illustrated, the controller 212 can include at least one server computer 230 and one or more databases 232 communicably coupled to the at least one server computer 230. In various embodiments, the at least one server computer 230 can store availability information for registered users of the communications system 200 in the one or more databases 232.

The registrar 216 is operable to contribute to facilitations of connections as discussed in greater detail below. In a typical embodiment, the registrar 216 may be constructed from, for example, one or more processing devices, one or more memory modules, and software that causes the processing device to operate according to one or more of the disclosed embodiments. For example, as illustrated, the registrar 216 can include at least one server computer 226 and one or more databases 228 communicably coupled to the at least one server computer 226. The one or more databases 228 can be utilized to store, for example, registration information for registered users of the communications system 200.

The connection subsystem 220 is operable to receive commands from the controller 212 and, in response to the commands, to establish connections with one or more of the user devices 208 over the communications system components 204. The connection establishment can include, for example, opening or engaging the use of physical or logical communications channels. The connection subsystem 220 can also bridge one or more separate connections to create, for example, a conference connection.

In a typical embodiment, the connection subsystem 220 may be constructed from, for example, one or more processing devices, one or more memory modules, and software that causes the processing device to operate according to one or more of the disclosed embodiments. The connection system may also include a suitable private branch exchange (“PBX”) or any other suitably configured dedicated telecommunications switching subsystem. For example, as illustrated, the connection subsystem 220 can include at least one server computer 234 and one or more databases 236 communicably coupled to the at least one server computer 230. In various embodiments, the at least one server computer 230 can store in the one or more databases 236 information related to current and historical connections, information related to commands received, for example, from the controller 212, and/or the like.

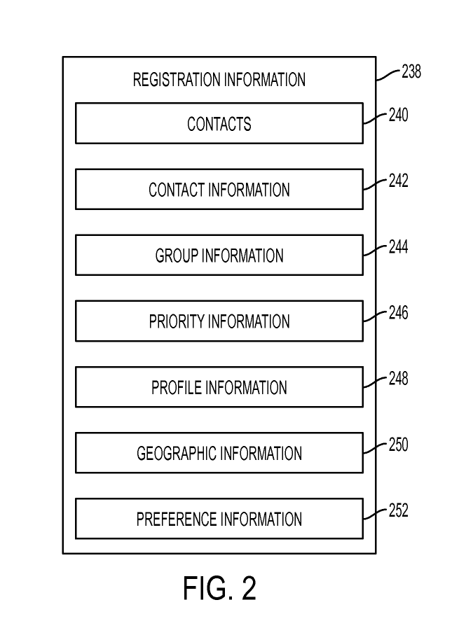

FIG. 2 illustrates an example of registration information 238 that can be stored, for example, in the one or more databases 228 of the registrar 216. The registration information 238 can relate, for example, to a particular registered user. The registration information 238 can include contacts 240, contact information 242, group information 244, priority information 246, profile information 248, geographic information 250, and preference information 252. It should be appreciated that, in any given implementation or for specific registered users, the registration information 238 can include more, less, and/or different information than illustrated.

For the particular registered user, the contacts 240 can identify, for example, other users with whom the particular registered user is willing and/or desires to have a connection. The contact information 242 can include, for example, information sufficient to identify a terminal of a communications system for purposes of establishing a connection with that terminal. For example, the contact information 242 can include one or more telephone numbers, one or more internet protocol (“IP”) addresses, one or more identifications or “handles” for one more communication services, and/or any other suitably sufficient information. The contact information 242 can relate to the particular registered user, the contacts 240 of the particular registered user, and/or the like.

The contact information 242 also can include more information than names and phone numbers. For example, certain embodiments may provide one or more questions that can be answered for any of the contacts 240 (e.g., “how do you know this contact?”). Further, some embodiments may provide pull-down or other menu selections for answers such as “childhood friend,” “relative,” “co-worker,” etc. In various embodiments, such information can be stored as part of the contact information 242.

The group information 244 can indicate or identify one or more of the contacts 240 as members of a group. For example, in certain embodiments, the group information 244 might identify each of the particular registered user's mother, father, and sister with the particular registered user's “family” group. By way of further example, the group information 244 might identify one or more of the particular registered user's former high school classmates and one or more of the particular registered user's former college classmates with the particular registered user's “alumni” group. As another example, the group information 244 might identify a “dating” group that includes one or more registered users whom the particular registered user is interested in becoming better acquainted with in a dating context.

The group information 244 can also include dynamically established groups. For example, on a particular day, a particular user can establish a group (e.g., a temporary group) of users with whom he or she would like talk with on that particular day. It should be appreciated that the foregoing designations are merely examples, and alternative embodiments may permit practically any number or kind of group designations, including a “none” or “no group” designation for indicating that any contact is not associated with any particular group.

The group information 244 can also include one or multiple layers of subgroups for each group. In this fashion, the group information 244 can include subgroup information that identifies one or more subgroups within each group. For example, the subgroup information might designate the particular registered user's grandmother, mother, and father as members of the particular registered user's “elders” subgroup, “parents” subgroup, or the like (within the particular registered user's “family” group). By way of further example, the subgroup information might also designate the particular registered user's brother and sister as members of the particular registered user's “siblings” subgroup (within the particular registered user's “family” group). It should be appreciated that the foregoing designations are merely examples, and alternative embodiments may permit practically any number or kind of group designations, including a “none” or “no subgroup” designation for indicating that any contact is not associated with any particular subgroup.

The priority information 246 can indicate a level or degree of the particular registered user's interest in having a dialogue with each contact of the contacts 240 relative to others of the contacts 240. For example, in various embodiments, the particular registered user can assign or ascribe priorities to each of the contacts 240 individually (i.e., contact-by-contact) and/or by group or subgroup. In the case of assigning or ascribing priorities by group or subgroup, such priorities can be ascribed to each contact that is a member of a given group or subgroup.

For example, in certain embodiments, the priority information 246 may indicate a priority of “5” for a contact with whom the particular registered user has a relatively high interest in having a dialogue, a priority of “1” for a contact with whom the particular registered user has a relatively low interest in having a dialogue, etc. The scale could also be reversed so that, for example, a priority of “5” represents a relative low interest and a priority of “1” represents a relative high interest.

In some embodiments, the particular registered user's priority designation for a particular contact of the contacts 240 or for a grouping thereof can be automatically lowered if, for example, the particular registered user has connected with the contact or group for more than a certain amount of time in a particular week. In similar fashion, in some embodiments, the particular registered user's priority designation for a particular contact of the contacts 240 or for a grouping thereof can be automatically raised if, for example, the particular registered user has not connected with the contact or group for more than a certain amount of time in a particular week. Such automatic changes to priority designations can be stored as part of the priority information 246.

It should be appreciated that the foregoing priorities are merely examples. Alternative embodiments may permit practically any number or kind of priorities, including various different numbers, letters, or other suitable priority identifications. For example, a “0” or other type of “none” priority may be used to indicate that the particular registered user has a neutral or no particularly high or low interest in having a dialogue with a contact. In addition, in various embodiments, the priority information 246 can allow the particular registered user to pre-select a group of contacts (e.g., one or more) for a specific day that takes priority over other ongoing prioritized lists or groups. In an example, on or around Mother's Day, the particular registered user may want to prioritize various women in his or her family. In another example, the particular registered user may want to prioritize the contacts 240 on or around their respective birthdays. Further, in some cases, the particular registered user may be permitted to identify each of the contacts 240 as prioritized or not prioritized (i.e., a Boolean designation).

The profile information 248 can include, for example, information related to interests, hobbies, skills, experience, and/or the like of the particular registered user. In an example, the profile information 248 can include the particular registered user's birthday. In another example, the profile information 248 can include dating-relevant information. For example, during a registration process, the particular registered user can be asked various compatibility questions. Answers to such questions can be stored as part of the profile information 248. The geographic information 250 can include information related to a residential address of the particular registered user (e.g., city, state, province, etc.), information related to a current geographic location of the particular registered user, etc. The current geographic location can be obtained, for example, via global-positioning-system (GPS) functionalities of a device associated with the particular registered user (e.g., one of the user devices 208).

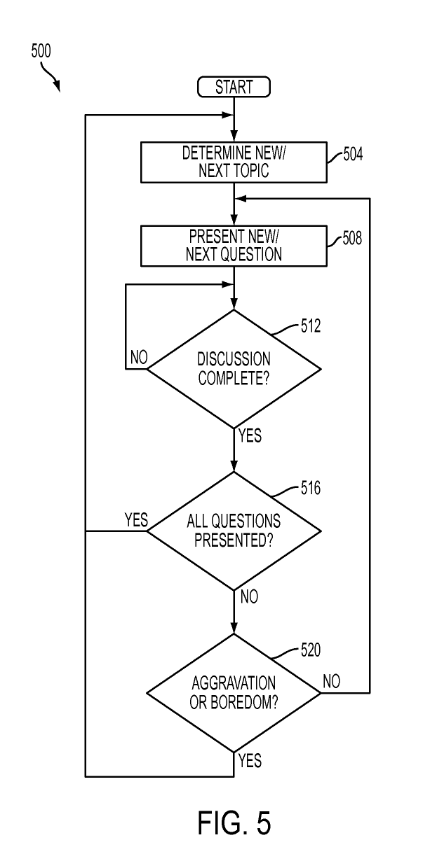

The preference information 252 can include stored user preferences such as, for example, whether the particular registered user desires conversation-guidance features with respect to all of the contacts 240, none of the contacts 240, some groups or subgroups of the contacts 240, etc. In various embodiments, as described in greater detail below, the contact information 242, the profile information 248, and/or the geographic information 250 can contribute to the conversation-guidance features. Examples of the conversation-guidance features will be described in greater detail with respect to FIG. 5.

In another example, the preference information 252 can indicate whether the particular registered user has enabled a birthday-prioritization feature. When the birthday-prioritization feature is enabled, the priority information 246 can be automatically updated to elevate priorities for all or a subset of the contacts 240 on or around their respective birthdays. In certain embodiments, the birthday-prioritization feature can help the particular registered user connect with those of the contacts 240 having a birthday. The birthday-prioritization feature can include, for example, notifying the particular registered user of a birthday just prior to establishing a connection (e.g., using a display or speaker of a corresponding user device).

It should be appreciated that registration is only one example of how users can identify other users as desired communication contacts. Users can be identified as desired communication contacts through membership to a common group (e.g. family, profession, or hobby). Alternatively, users can be identified as desired communication contacts through accessing other software programs on the user device such as an email or instant messaging application. The disclosed embodiments may function with the registration process, portions of the registration process, or without a registration process entirely.

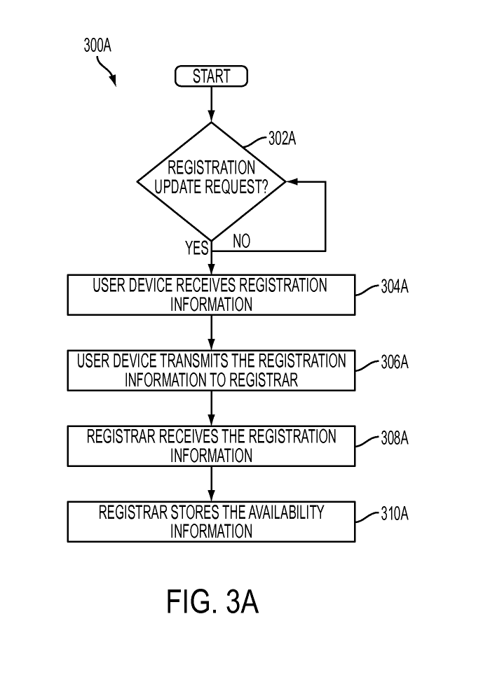

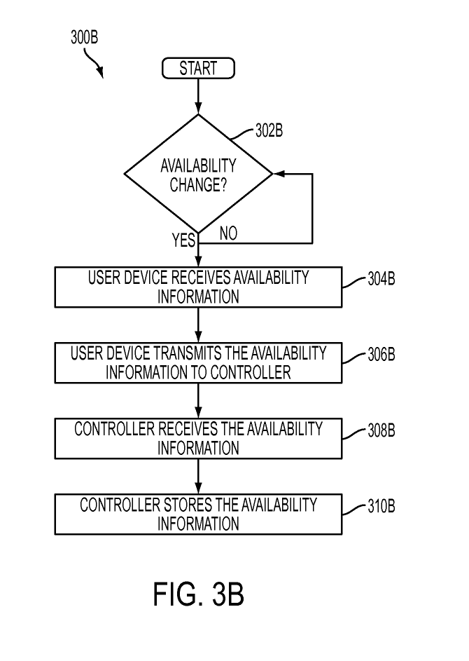

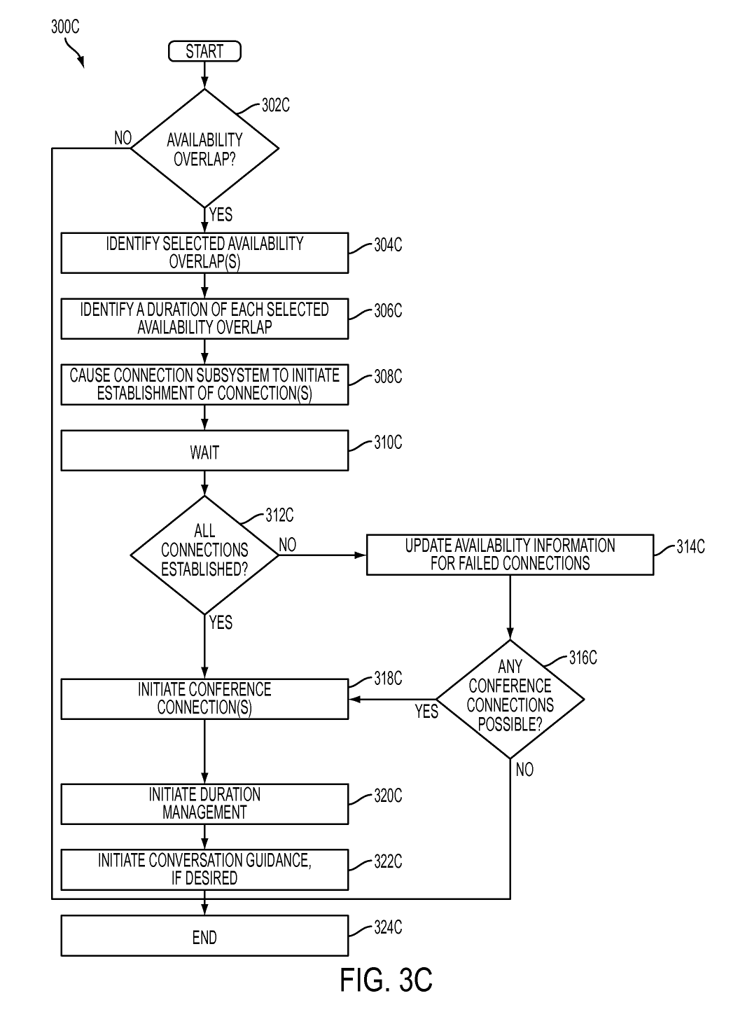

FIG. 3A illustrates an example of a process 300A for registering unregistered users and/or updating registration information for registered users. For purposes of simplicity, both new registrations and updates to existing registrations may be referenced herein as registration updates. By way of example, the process 300A, in whole or in part, can be implemented by one or more of the registrar 216, the controller 212, the connection subsystem 220, and/or the user devices 208. The process 300A can also be performed generally by the communications system 200 of FIG. 1. Although any number of systems, in whole or in part, can implement the process 300A, to simplify discussion, the process 300A will be described in relation to specific systems or subsystems of the system 200. In various embodiments, the process 300A can be performed with respect to each of the user devices 208 of FIG. 1.

In various embodiments, the process 300A can be performed repeatedly such that, for example, the user devices 208 of FIG. 1 each constantly check for updated registration information. In other embodiments, the process 300A can be performed at certain intervals (e.g., every five minutes). In still other embodiments, the process 300A can be performed responsive to new or updated information from users of the user devices 208. The process 300A can also be triggered manually by a user of one of the user devices 208 or in another suitable manner.

At decision block 302A, a particular user device of the user devices 208 determines whether it has received a registration update request from its user. In a typical embodiment, each of the user devices 208 is configured to receive suitable inputs from a respective user through a respective user interface. In various embodiments, the registration update request can be representative of a new registration. The registration update request can also be representative of a change to registration information such as a change to any of the registration information 238 of FIG. 2. If it is determined at the decision block 302A that a registration update request has been received, the process 300A proceeds to block 304A. Otherwise, the process 300A remains at the decision block 302A until such a request is received.

At block 304A, the particular user device receives the registration information. In general, the registration information can include any of the information described with respect to the registration information 238 of FIG. 2. For example, the registration information can include new contacts, new group or subgroup information, new priority information, new contact information, new profile information, and/or the like. At block 306A, the particular user device transmits the registration information to the registrar 216. At block 308A, the registrar 216 receives the registration information from the particular user device. At block 310A, the registrar 216 stores the registration information, for example, in the one or more databases 228.

FIG. 3B illustrates an example of a process 300B for updating availability information. In various embodiments, the process 300B can be performed with respect to each of the user devices 208 of FIG. 1. By way of example, the process 300B, in whole or in part, can be implemented by one or more of the registrar 216, the controller 212, the connection subsystem 220, and/or the user devices 208. The process 300B can also be performed generally by the communications system 200 of FIG. 1. Although any number of systems, in whole or in part, can implement the process 300B, to simplify discussion, the process 300B will be described in relation to specific systems or subsystems of the system 200.

In various embodiments, the process 300B can be performed repeatedly such that, for example, the user devices 208 of FIG. 1 each constantly check for availability information. In other embodiments, the process 300B can be performed at certain intervals (e.g., every five minutes). In still other embodiments, the process 300B can be performed responsive to new or updated information from users of the user devices 208. The process 300B can also be triggered manually by a user of one of the user devices 208 or in another suitable manner.

At decision block 302B, a particular user device of the user devices 208 determines whether it has received a change in availability information from its respective registered user. In various embodiments, a change in availability can be indicated directly or indirectly by the registered user. For example, the change in availability may be indicated in response to a cancelled appointment, a need for a break from work, unexpected downtime (e.g., at a bus station or a doctor's office), and/or the like.

For example, a change in availability information may be indicated directly by a registered user as a result of inputting new or updated availability information into the respective user device. For example, the new or updated availability information might indicate: (1) that the registered user has presently become available to dialogue with anyone for the next fifteen minutes or any other amount of time; (2) that the registered user has presently become available to dialogue with only one of that registered user's contacts, Jake Bacon, for the next twenty minutes or any other amount of time; (3) that the registered user is available to dialogue with only three of that registered user's contacts, Russ Fenton, Dan Smith, and Michael Wood, for the next two hours or any other amount of time; (4) that the registered user has presently become available to dialogue with anyone in that registered user's “family” group; or (5) that the registered user is presently available (or expects to become available later) to dialogue with one or more specified or unspecified contacts or one or more groups or subgroups for any other amount of time. It should be appreciated that the foregoing inputs are merely examples.

In certain embodiments, the registered user can temporarily pause any number of his/her availabilities by inputting an associated time period during which the user will not be available (e.g., not available at all for the next sixty minutes, or not available for any connections with the “family” group for the next two hours, etc.). This may be beneficial if, for example, the registered user receives a knock on their door from a neighbor during a period of availability. After conversing with the neighbor, the registered user can manually remove the pause status.

Additionally, in certain embodiments, a change in availability information may be made indirectly, for example, via the registered user posting or removing an appointment on an electronic calendar on the particular user device. In certain embodiments, the decision block 302B can include periodically examining indicative data that the registered user may have input into the particular user device through, for example, a calendar application/software.

In some embodiments, the registered user's availabilities can be automatically paused without user input. For example, the particular user device can detect when the registered user is communicating thereon and pause the registered user's availability accordingly. Consider an example in which the registered user's availability information indicates availability for one hour. Ten minutes into the one-hour availability, the registered user may receive a phone call on the particular user device. In some cases, the phone call may be unrelated to operation of a system such as the system 200 of FIG. 1. In other cases, the phone call may result from a connection established via a system such as the system 200 of FIG. 1. In either case, the particular user device may automatically pause the registered user's availability responsive to the phone call. After the phone call ends, the particular user device can automatically remove the pause status.

In a typical embodiment, the controller 212 refrains from initiating establishment of connections (or additional connections) involving the registered user while the registered user's availability is paused. However, since it is only a pause, in some cases the controller 212 may plan future connections with the registered user's availability information in mind. For example, if a connection opportunity is identified during the pause, the registered user and his contact could be connected immediately after the pause period. In other cases, the controller 212 may further refrain from planning future connections involving the registered user while the registered user's availability is paused. In these cases, the registered user may be considered unavailable until the pause ends.

If it is determined at the decision block 302B that a change in availability information has been received, the process 300B proceeds to block 304B. Otherwise, the process 300B remains at the decision block 302B until such a change in availability information is received. At block 304B, the particular user device receives the availability information. The availability information can include, for example, corresponding start/end times and/or durations (e.g., in minutes) of the registered user's availabilities.

In many cases, a start time of availability may be immediate. In other cases, the availability information can indicate future availability start times (e.g., that the registered user will be available for a ten-minute dialogue with anyone at 2:00 pm, that the registered user will be available for a thirty-minute dialogue with a particular one of his contacts, Dave Slye, at 3:00 pm, that the registered user will be available for a dialogue with any of his siblings on an upcoming Saturday at 2:00 pm, etc.). In some embodiments, the availability information can indicate availability durations and delay durations (e.g., that the registered user will be available for twenty-five minutes starting in one hour). Moreover, as noted above, it should be appreciated that alternative embodiments may condition and/or indicate availabilities in practically any number of ways.

At block 306B, the particular user device transmits the availability information to the controller 212. In various embodiments, the particular user device can automatically (i.e. without user intervention) transmit the availability information and minimize disturbing its respective user. At block 308B, the controller 212 receives the availability information from the particular user device. At block 310B, the controller 212 stores the availability information, for example, in the one or more databases 232.

FIG. 3C illustrates an example of a process 300C for establishing and managing connections. This process can be at different stages for different users and their respective user devices. By way of example, the process 300C, in whole or in part, can be implemented by one or more of the registrar 216, the controller 212, the connection subsystem 220, and/or the user devices 208. The process 300C can also be performed generally by the communications system 200 of FIG. 1. Although any number of systems, in whole or in part, can implement the process 300C, to simplify discussion, the process 300C will be described in relation to specific systems or subsystems of the system 200.

In various embodiments, the process 300C can be performed repeatedly such that, for example, the controller 212 of FIG. 1 constantly looks to establish and manage new connections. In other embodiments, the process 300C can be performed at certain intervals (e.g., every five minutes). In still other embodiments, the process 300C can be performed responsive to new or updated information such as, for example, responsive to new or updated registration information, new or updated availability information, and/or the like. The process 300C can also be triggered manually by a user or administrator or in another suitable manner.

At decision block 302C, the controller 212 determines whether any availability overlaps among registered users can be identified. For example, the controller 212 can identify availability overlaps by comparing, for each registered user, each of that registered user's availabilities to all availabilities of all other registered users who are both: (1) contacts of that registered user; and (2) members of any of that registered user's groups or subgroups to which any of that registered user's availabilities are limited, if the availabilities are so limited. In this manner, the decision block 302C can include reviewing and evaluating group information and availability information of each registered user. If the controller 212 identifies any availability overlaps, the process 300C proceeds to block 304C. Otherwise, the process 300C proceeds to block 324C and ends.

At block 304C, the controller 212 identifies one or more selected availability overlaps. It should be appreciated that, in some cases, the block 302C can result in more than one availability overlap being identified for particular users. The block 302C can also result in conflicts. For example, a particular registered user may be needed for more than one separate connection; however, it may be that the particular registered user's availability is such that only one of the separate connections can be established at a given time. In general, the block 304C includes performing functionality to select from a set of availability-overlap choices, resolve conflicts, etc. The block 304C can also include reviewing and applying priority information such as the priority information 246 of FIG. 2. Each selected availability overlap generally corresponds to at least one conference connection that will be attempted as described below. Identification of the selected availability overlap is discussed in greater detail below in connection with Operational Scenarios Nos. 1-4.

At block 306C, the controller 212 identifies a duration of each selected availability overlap. At block 308C, the controller 212 sends a suitable signal to the connection subsystem 220 to cause the connection subsystem 220 to initiate establishment of one or more connections among the registered users corresponding to each selected availability overlap. In some embodiments, the connection subsystem 220 may initiate establishment of a connection to a particular user by calling the user (e.g. landline or VoIP). In other embodiments, the connection subsystem 220 may signal a user device to call the subsystem 220 itself.

It should be appreciated that it may be desirable to avoid attempting to establish a connection with one of the user devices 208 and having its user not answer. In certain embodiments, not answering may include the user having an available connection but not answering his or her phone, the user already being on the phone such that a busy signal is received, etc. One way to minimize this circumstance is to have the communications system 200 first reach out to the user most likely to not answer before trying to establish a connection with other users. To determine the user most likely to not answer, the controller 212 may consider, for example, one or more of the following factors: (1) duration since availability status was indicated; (2) status update from user device software; and (3) user history of not answering.

Regarding factor (1), in a typical embodiment, a reasonable assumption may be that the likelihood of the user not answering increases in proportion to a time elapsed since the user indicated that he or she was available. Regarding factor (2), in some embodiments, software on a user device may periodically monitor user inputs once the user has indicated availability. The monitoring can include, for example, determining whether the user has entered any inputs for any program on the device. If so, the user device software may update a user-status indicator that is accessible to the controller 212 to “active.” The user-status indicator can also be associated with a timestamp corresponding to when the user-status indicator was updated. The controller 212 can use the user-status indicator to determine a time elapsed since the user-status indicator was last indicated to be “active.” In certain embodiments, a likelihood that the user will not answer may be determined to increase in proportion to this time elapsed.

Regarding factor (3), in a typical embodiment, the controller 212 records each time any user cannot be reached for a connection while having an available status. In various embodiments, it may be reasonable to assume that the likelihood of the user not answering future calls increases in proportion to a number or percentage of times that the user has not answered calls in the past (e.g., for a predetermined range of time). In some embodiments, each user's history of missed calls can be cleared to zero after the user answers a certain consecutive number of calls (e.g., ten). Below are examples of the above-mentioned factors.
Factor 1
Time since Availability Indication
0-20 minutes: 0 points
21-40 minutes: 1 point
41-60 minutes: 2 points
60 minutes+: 3 points
Factor 2
Time since “Active” Status
0-20 minutes: 0 points
21-40 minutes: 1 point
41-60 minutes: 2 points
60 minutes+: 3 points
Factor 3
Number of missed calls (1 point for each missed call in the past)
0 missed: 0 points
1 missed: 1 point
2 missed: 2 points
3 missed: 3 points
etc.

In a typical embodiment, for each user, the controller 212 can add the points from each factor to arrive at a total user score, with a higher score roughly indicating a greater likelihood that the user will not answer. In a typical embodiment, the controller 212 can first attempt to initiate establishment of a connection with the device of the user most likely to not answer. Subsequently, if a connection is made with the device of the user most likely to not answer, the controller 212 can move on to the others of the user devices 208 that are to be connected pursuant to a given selected availability overlap. In various embodiments, the controller 212 can iterate from most likely to not answer to least likely to not answer.

At block 310C, the controller 212 waits a suitable amount of time to allow the connection subsystem 220 to establish each of the connections. At decision block 312C, the controller 212 determines whether all connections have been established. If the controller 212 determines that all connections have been established, the process 300C proceeds to block 318C. Otherwise, the process 300C proceeds to block 314C.

At block 314C, the controller 212 updates the availability information for registered users for whom connection establishment has failed due, for example, to those registered users not answering. For example, the availability information of those registered users can be updated to reflect unavailability for a suitable time-out period. For example, the time-out period can be five minutes, an hour, or any other suitable amount of time for purposes of reducing a number of failed connection attempts. After block 314C, the process 300C proceeds to decision block 316C.

At decision block 316C, the controller 212 determines whether any conference connections are possible based on the established connections. For example, the decision block 316C can involve ascertaining whether there are any potential conference connections for which connections have been established for all conference participants. If it is determined at the decision block 316C that at least one conference connection is possible, the process 300C proceeds to block 318C. Otherwise, the process 300C proceeds to the block 324C and ends.

At block 318C, for each possible conference connection, the controller 212 sends a suitable signal to the connection subsystem 220 that causes the connection subsystem 220 to initiate establishment of a conference connection among the registered users participating in the conference connection. The conference connection may be between two registered users and the connection subsystem 220 or more than two registered users and the connection subsystem 220 depending on the results of block 304C. In general, the conference connection expands to include the established connections to the participating registered users, for example, by bridging those connections.

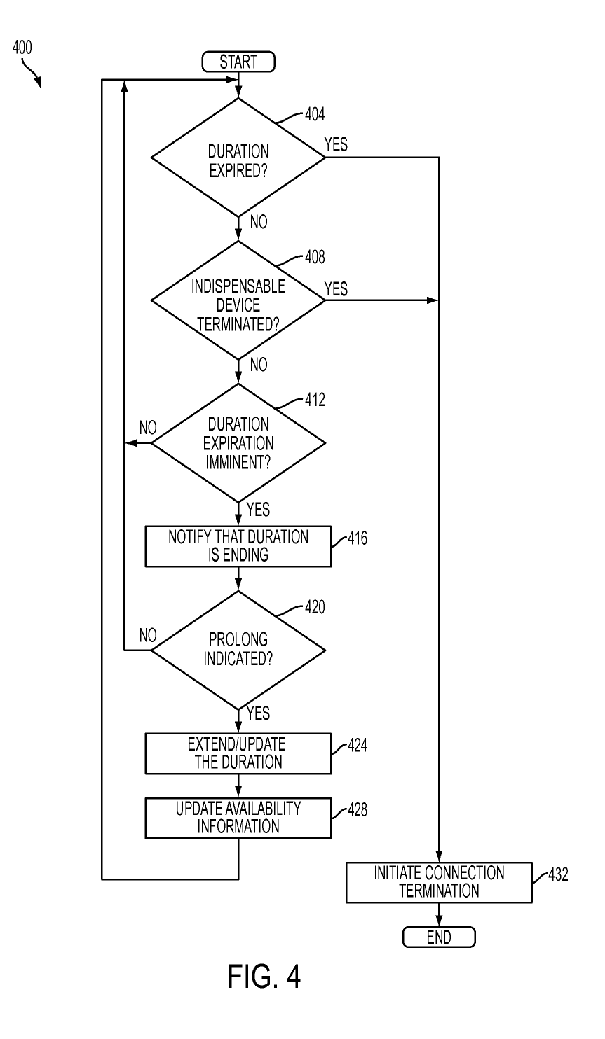

In some cases, the block 318C can encompass expanding an in-progress conference connection to include a connection to a device of an additional registered user. For example, participants in the in-progress conference connection may request inclusion of the additional registered user, the additional registered user may have spontaneously become available as described above, etc. At block 320C, the controller 212 initiates its duration-management features. Examples of the duration-management features will be described in greater detail with respect to FIG. 4.

At block 322C, the controller 212 initiates conversation-guidance features for each conference connection in which it is desired. In a typical embodiment, each user has an option of requesting the conversation-guidance features (e.g., as part of the registration information). For a given conference connection, conversation-guidance features can be considered to be desired if, for example, all users who have been connected in the conference connection have requested the conversation-guidance features. An example of the conversation-guidance features will be described in greater detail with respect to FIG. 5. After block 322C, the process 300C proceeds to the block 324C and ends.

For ease of illustration and description, the process 300C is described above as including particular blocks executed in a particular sequence. However, it should be appreciated that, in many cases, such blocks can be executed concurrently with other blocks. In an example, as described above, the block 304C can result in a selected availability overlap being identified for each of a plurality of conversations. In such cases, the process 300C may proceed independently with respect to each conversation. For instance, the process 300C can include initiating duration management at the block 320C for one conversation while initiating a conference connection at the block 318C for a different conversation.

In another example, multiple iterations of the process 300C can execute in parallel. In some cases, an independent iteration of the process 300C can be executed for a certain registered user, particular subsets of registered users, etc. Independent iterations can also be executed at particular intervals, as new availability or registration information becomes available, and/or the like. Each such iteration can proceed in the manner described above.

FIG. 4 illustrates an example of a process 400 for duration management. By way of example, the process 400, in whole or in part, can be implemented by one or more of the registrar 216, the controller 212, the connection subsystem 220, and/or the user devices 208. The process 400 can also be performed generally by the communications system 200 of FIG. 1. Although any number of systems, in whole or in part, can implement the process 400, to simplify discussion, the process 400 will be described in relation to specific systems or subsystems of the system 200.

Duration management may, in some embodiments, help limit the connection duration to an appropriate duration in view of each user's availability—which generally overlap but are typically not identical. For example, one user may have an availability for the next 60 minutes, the other user for only 20 minutes. Duration management in the foregoing example may help limit the connection to 20 minutes—the period of time acceptable to both users. In a typical embodiment, the process 400 is generally executable to count down a time remaining in a particular selected availability overlap and automatically initiate termination of a connection made when the selected availability overlap expires. In various embodiments, the process 400 can be performed as all or part of the block 320C of FIG. 3C for each conference connection established pursuant to the process 300C of FIG. 3C. At decision block 404, the controller 212 determines whether a duration of the particular selected availability overlap has expired. If the duration has expired, the process 400 proceeds to block 432. Otherwise, the process 400 proceeds to decision block 408.

At decision block 408, the controller 212 determines whether an indispensable device (e.g., a user device of the user devices 208 that corresponds to a necessary or indispensable registered user to a conference connection) has terminated its connection to the other devices participating in the conversation. It should be appreciated that in some multi-party connections (e.g., a conference connection among three or more parties), one or more of the parties may be indispensable. For example, while estranged siblings may not wish to speak with each other separately on Mother's Day, they may participate in a conference call with her at a mutually available time and, upon her termination of her connection, automatic termination of the remaining connections among the estranged siblings may be desirable. In many cases, all parties can be considered indispensable. If it is determined at the decision block 408 that an indispensable device has terminated its connection, the process 400 proceeds to block 432. Otherwise, the process 400 proceeds to decision block 412.

At decision block 412, the controller 212 determines whether expiration of the duration is imminent. In a typical embodiment, expiration of the duration is “imminent” when the duration will expire within a configurable amount of time (e.g., two minutes). It should be appreciated that, in various embodiments, the controller 212 may regard any suitable amount of time remaining in the duration as indicating an imminent expiration of the duration. If the controller 212 determines that expiration of the duration is imminent, the process 400 proceeds to block 416. Otherwise, the process 400 returns to the block 404 and proceeds as described above.

At block 416, the controller 212 notifies each of the user devices 208 that is participating in the conversation that the duration is ending. At decision block 420, the controller 212 determines whether any of the user devices 208 that is participating in the conversation has indicated a user's desire to prolong the duration. In a typical embodiment, such an indication may be made, for example, by pressing the number “3” on a user device, or in any other suitable manner. If the controller 212 determines that a user has indicated a desire to prolong the conversation, the process 400 proceeds to block 424. Otherwise, the process 400 returns to block 404 and proceeds as described above.

At block 424, the controller 212 extends the duration for a configurable amount of time (e.g., five minutes). At block 428, the controller 212 updates the availability information for all registered users participating in the conversation to indicate their unavailability for the extended duration. After block 428, the process 400 returns to block 404 and proceeds as described above.

At block 432, the controller 212 sends a suitable signal to the connection subsystem 220 to cause the connection subsystem 220 to initiate connection termination. In general, connection termination can involve disconnecting individual connections to those of the devices 208 participating in the conversation.

FIG. 5 illustrates an example of a process 500 for providing conversation-guidance features to a set of participating registered users in a conversation. This feature may be useful to those users who are not the greatest conversationalists but still want to connect with others. This feature may also be useful to any user who wants to deviate from typical conversations. Utilization of this feature may help users learn something new about their contacts through answers to questions that likely would not otherwise be part of the conversation. By way of example, the process 500, in whole or in part, can be implemented by one or more of the registrar 216, the controller 212, the connection subsystem 220, and/or the user devices 208. The process 500 can also be performed generally by the communications system 200 of FIG. 1. Although any number of systems, in whole or in part, can implement the process 500, to simplify discussion, the process 500 will be described in relation to specific systems or subsystems of the system 200.

In various embodiments, the process 500 can be performed as all or part of the block 322C of FIG. 3C. In certain embodiments, the process 500 can be initiated at a beginning of the conversation, for example, as a result of being specified in preferences (e.g., the preference information 252 of FIG. 2) of one or more of the participating registered users. In other embodiments, the process 500 can be initiated during the conversation, for example, responsive to at least one of the participating registered users performing an initiation command such as, for example, speaking a corresponding command utterance (e.g., “turn questioning on”), pressing a corresponding button, etc. In certain embodiments, the participating registered users can conclude the process 500 by performing a conclusion command such as, for example, speaking a corresponding command utterance (e.g., “turn questioning off”), pressing a corresponding button, etc. In certain embodiments, the process 500 can continue until a conclusion command is received, the conversation is terminated, and/or the like.

At block 504, the controller 212 determines a new or next topic of conversation for the participating registered users. In certain embodiments, as part of the block 504, the controller 212 can review registration information such as, for example, the registration information 238 of FIG. 2. For example, the controller 212 can review the group information 244, the profile information 248, the geographic information 250, and/or the like for each of the participating registered users. The controller 212 can also review any answers to registration questions provided by the registered users participating in the conversation. For example, if the contacts are part of the “family” group, the new or next topic could support family-relevant questions (e.g.: “Are you planning on traveling this year to visit any family members?” and “What are your holiday plans?”).

In certain embodiments, the topic determination can be responsive to a topic command from the participating registered users. For example, the participating registered users can speak topic-command utterances such as “funny questions,” “sports questions,” “political questions,” “family questions,” “work questions,” and/or the like that each correspond to a particular topic. In such cases, the determined topic can be a topic specified by the topic command. In various embodiments, the process 500 can return to the block 504 intermittently responsive to a change-topic command from the participating registered users such as, for example, a corresponding command utterance (e.g., “next category,” “new topic,” etc.), a corresponding button press, and/or the like.

At block 508, the controller 212 presents a new or next question within the determined topic to all or a portion of the participating registered users. In certain embodiments, the controller 212 may direct the question to a specific participating registered user. In these embodiments, the controller 212 can attempt to equally distribute to whom questions are directed, for example, by following a rotation. At each iteration of the block 508, the controller 212 can select the same or different question when proceeding through the rotation. In some embodiments, as an alternative to directing questions to particular participating registered users, the controller 212 can direct the question to all of the participating registered users in a manner that encourages discussion and interaction. In these embodiments, the participating registered users can be allowed to self-moderate the order and manner in which the question is answered.

In various embodiments, the process 500 can return to the block 508 intermittently responsive to a new-question command from one or more of the participating registered users. For example, the new-question command could be an utterance (e.g., “next question,” “previous question,” etc.), a corresponding button press, and/or the like. In such cases, the controller 212 can present a question in accordance with the new-question command.

At decision block 512, the controller 212 determines whether discussion related to the question is complete. In certain embodiments, the discussion related to the question can be determined to be complete when silence has been detected (e.g. via monitoring the discussion) for a configurable interval (e.g., fifteen seconds). If the controller 212 determines that the discussion related to the question is complete, the process 500 proceeds to decision block 516. Otherwise, the process 500 remains at the decision block 512 until the discussion related to the question is determined to be complete.

At decision block 516, the controller 212 determines whether all questions on the determined topic have been presented to the participating registered users. If the controller 212 determines that all questions on the determined topic have been presented, the process 500 returns to block 504 for determination of another topic. Otherwise, the process 500 proceeds to decision block 520.

At decision block 520, the controller 212 determines whether aggravation and/or boredom have been detected. Aggravation and/or boredom, if detected, can mean that a different topic should be determined. In certain embodiments, aggravation can be detected as a function of a high rate of answer (e.g., unusually fast speech measured in words per minute) and/or loud speech volume of one, multiple, or all of the participating registered users. In certain embodiments, boredom can be detected as a function of a slow rate of answer (e.g., fewer than a configurable number of words have been detected over a preceding minute), a certain number pauses have been detected (e.g., five silence intervals of five seconds), and/or the like. If the controller 212 determines that boredom and/or aggravation has been detected, the process 500 can return to the block 504 for determination of another topic. Otherwise, the process 500 returns to the block 508 for presentation of another question on the determined topic.

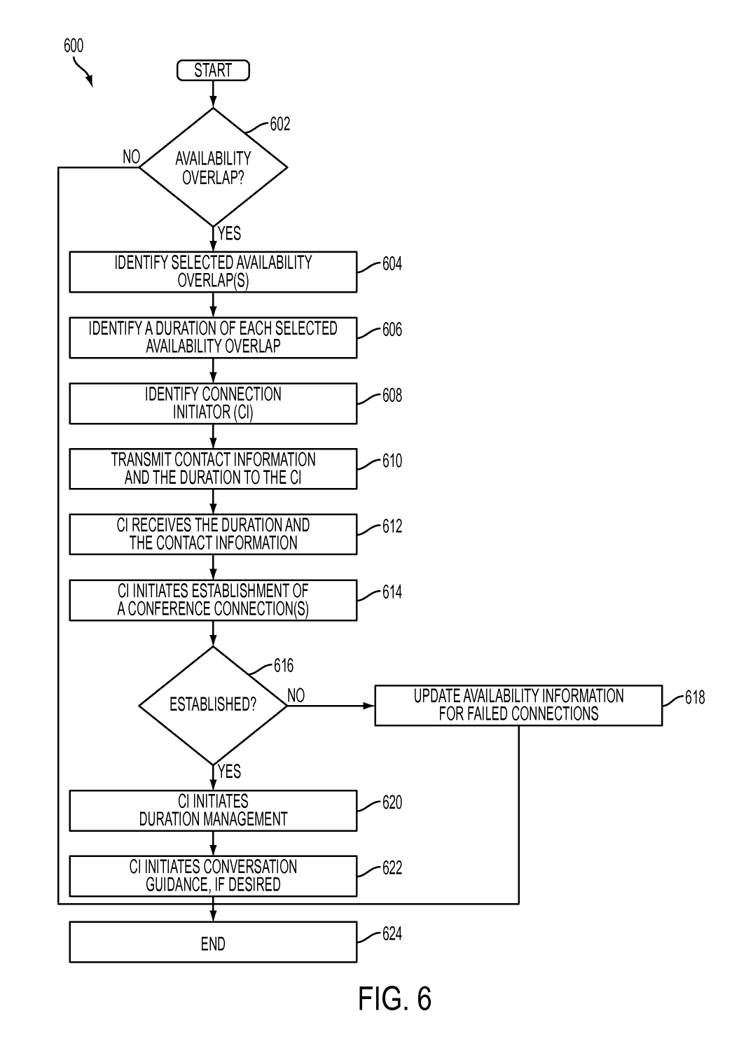

FIG. 6 illustrates an example of a process 600 for establishing and managing connections. By way of example, the process 600, in whole or in part, can be implemented by one or more of the registrar 216, the controller 212, the connection subsystem 220, and/or the user devices 208. The process 600 can also be performed generally by the communications system 200 of FIG. 1. Although any number of systems, in whole or in part, can implement the process 600, to simplify discussion, the process 600 will be described in relation to specific systems or subsystems of the system 200.

In various embodiments, the process 600 can be an alternative to a process such as the process 300C of FIG. 3C. For example, certain functionality attributed to the controller 212 in the process 300C can instead be distributed to other systems or components such as, for example, one or more of the user devices 208. In various embodiments, centralized components such as the controller 212 and client components such as one or more of the user devices 208 can collaborate to perform the process 600. In various embodiments, one or more of the user devices 208 collaborate to perform the process 600 without any centralized components such as the controller 212.

In various embodiments, the process 600 can be performed repeatedly such that, for example, the controller 212 of FIG. 1 constantly looks to establish and manage new connections. In other embodiments, the process 600 can be performed at certain intervals (e.g., every five minutes). In still other embodiments, the process 600 can be performed responsive to new information such as, for example, responsive to new or updated registration information, new or updated availability information, and/or the like. The process 600 can also be triggered manually by a user or administrator or in another suitable manner.

In general, blocks 602-606 can be performed by the controller 212 as described with respect to blocks 302C-306C of FIG. 3C. Blocks 602-606 can yield, for example, one or more selected availability overlaps and a duration of each such selected availability overlap. Each selected availability overlap generally corresponds to a connection that will be attempted among a set of registered users.

At block 608, for each selected availability overlap, the controller 212 identifies a particular user device of the user devices 208 as a connection initiator. For each selected availability overlap, the connection initiator generally corresponds to a user device associated with a registered user from the corresponding set of registered users. In various embodiments, the connection initiator can correspond, for example, to a registered user who is most likely to answer (e.g., see block 308C of FIG. 3C), a registered user who is least likely to answer (e.g., see block 308C of FIG. 3C), a registered user who indicated (or first indicated) a desire to have the connection, and/or the like. In some cases, the controller 212 may identify more than one connection initiator for a given selected availability overlap. For example, if the corresponding set of registered users includes two users, the controller 212 may identify two of the user devices 208 as connection initiators (e.g., a user device associated with a first of the two users and a user device associated with a second of the two users). In these cases, each connection initiator can attempt to establish connections in the fashion described below.

At block 610, for each connection to be attempted, the controller 212 transmits to each connection initiator the duration of the selected availability overlap and contact information for the corresponding set of registered users (optionally excluding contact information for the connection initiator). The contact information can include information similar to the contact information 242 of FIG. 2. In a typical embodiment, the controller 212 may transmit the contact information to an IP address of the connection initiator, send text messages via short message service (“SMS”) or multimedia messaging service (“MMS”), etc. With regard to SMS and MMS, such messages may start with a predefined indicator such as, for example, “USERAVAILABILITY” or “CONFERENCETIME.” It should be appreciated that blocks 612-624 are generally performed by each connection initiator. However, for simplicity of description, blocks 612-624 will be described with respect to a particular connection initiator.

At block 612, the particular connection initiator receives the respective duration and the respective contact information. In various embodiments, the particular connection initiator can automatically (i.e. without user intervention) read any incoming messages and minimize disturbing its respective registered user. At block 614, the particular connection initiator initiates establishment of a connection using the received contact information. In some embodiments, the particular connection initiator can send suitable signals to the connection subsystem 220 to cause the connection subsystem 220 to initiate establishment of the connection. In these embodiments, the block 614 can including performing functionality described with respect to the blocks 308C-318C except that such functionality is facilitated by the particular connection initiator rather than by the controller 212. In other embodiments, the particular connection initiator can form a conference connection by initiating separate connections with each registered user of the respective set of registered users and bridging those connections. In the case of more than one separate connection needing to be established, multi-way calling or conference-call features of the particular connection initiator can be utilized. In various embodiments, the particular connection initiator can also automatically initiate the establishment of a connection and minimize disturbing its respective registered user.

At decision block 616, the particular connection initiator determines whether the connection(s) have been successfully established. If it is determined that the connection(s) have been successfully established, the process 600 proceeds to block 620. Otherwise, the process 600 proceeds to block 618. In some embodiments, if a connection initiator determines that the connection(s) has been successfully established, the connection initiator will alert the its respective user of the connection by, for example, ringing an audible alarm, vibrating the user device, and/or displaying a message on the display of the user device.

At block 618, the particular connection initiator causes the controller 212 to update the availability information for registered users for whom connection establishment failed, for example, due to those registered users not answering. For example, the availability information of those registered users can be updated to reflect unavailability for a suitable time-out period. For example, the time-out period can be five minutes, an hour, or any other suitable amount of time for purposes of reducing a number of failed connection attempts. After block 618, the process 600 proceeds to block 624 and ends.

At block 620, the particular connection initiator performs duration management by implementing, for example, the process 400 of FIG. 4. However, it should be appreciated that, at the block 620, such functionality is facilitated by the particular connection initiator rather than by the controller 212. At block 622, the particular connection initiator initiates conversation-guidance features, if desired, by implementing, for example, the process 500 of FIG. 5. It should be appreciated, however, that such functionality is facilitated by the particular connection initiator rather than by the controller 212. At block 624, the process 600 ends.

For ease of illustration and description, the process 600 is described above as including particular blocks executed in a particular sequence. However, it should be appreciated that, in many cases, such blocks can be executed concurrently with other blocks. In an example, as described above, the block 604 can result in a selected availability overlap being identified for each of a plurality of conversations. In such cases, the process 600 may proceed independently with respect to each conversation. For instance, the process 600 can execute the block 608 for one conversation while executing the block 610 for another conversation.

In another example, multiple iterations of the process 600 can execute in parallel. In some cases, an independent iteration of the process 600 can be executed for a certain registered user, particular subsets of registered users, responsive to an administrative trigger, etc. Independent iterations can also be executed at particular intervals, as new availability or registration information becomes available, and/or the like. Each such iteration can proceed in the manner described above

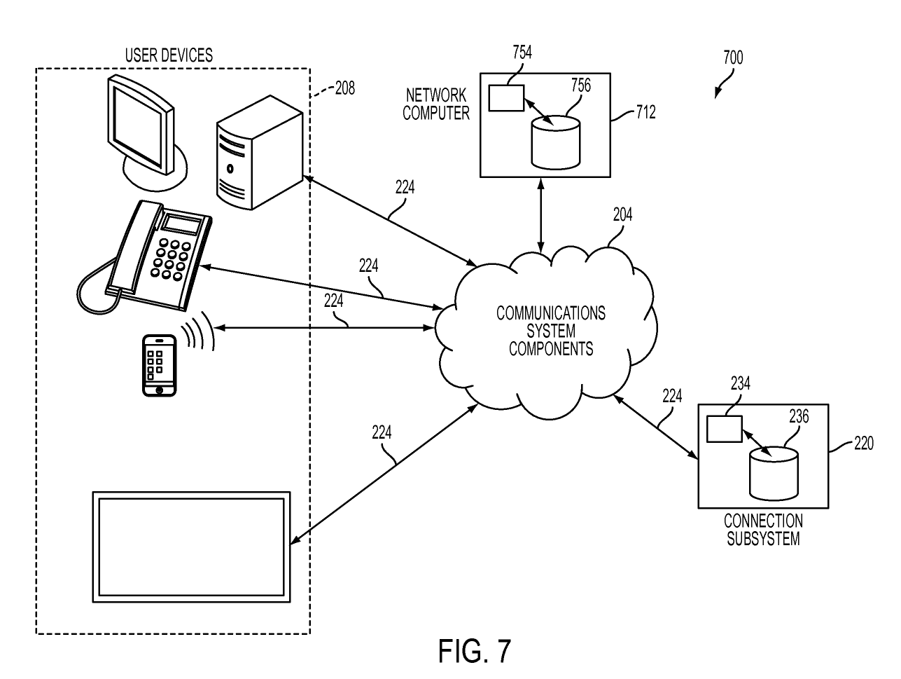

FIG. 7 illustrates an alternative communications system 700 equipped to facilitate connections. As shown, the communications system 700 includes a network computer 712. The network computer 712 is operable to provide IP addresses or other contact information to the user devices 208 of the communications system 700. In a typical embodiment, the network computer 712 may be constructed, for example, from one or more processing devices, one or more memory modules, and software that causes the processing device to operate according to one or more of the disclosed embodiments. For example, as illustrated, the network computer 712 can include at least one server computer 754 and one or more databases 756 communicably coupled to the at least one server computer 754. Construction of the remaining components of the communications system 700 is discussed above (in connection with FIG. 1). In some embodiments, the connection subsystem 220 can be eliminated if, for example, the user devices 208 initiate all connections.

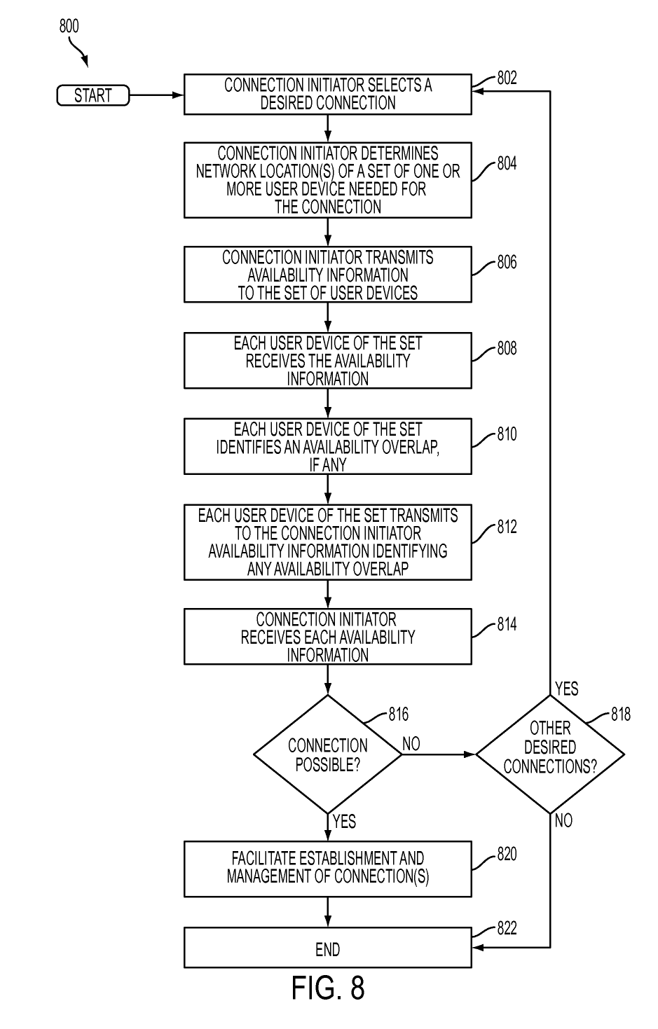

In certain embodiments, the user devices 208 can each implement, with respect to a particular registered user, functionality described with respect to the registrar 216, the controller 212, and/or the connection subsystem 220 of FIG. 1. For example, the user devices 208 can each maintain and store registration information and availability information for a corresponding particular registered user in memory thereof. The registration information can be similar, for example, to the registration information 238 of FIG. 2. In certain embodiments, as described in greater detail with respect to FIG. 8, the system 700 can facilitate peer-to-peer connections among the user devices 208.

FIG. 8 illustrates an example of a process 800 for establishing and managing connections in a peer-to-peer fashion. By way of example, with reference to FIG. 7, the process 800, in whole or in part, can be implemented by one or more of the user devices 208, the network computer 712, and/or the connection subsystem 220. The process 800 can also be performed generally by the communications system 700 of FIG. 7. Although any number of systems, in whole or in part, can implement the process 800, to simplify discussion, the process 800 will be described in relation to specific systems or subsystems of the system 200.

In a typical embodiment, the process 800 is initiated and performed with respect to a connection initiator. In general, the connection initiator can be a user device such as, for example, any one of the user devices 208 of FIG. 1 and/or FIG. 7. In addition, in various embodiments, separate iterations of the process 800 can be performed with respect to each of the user devices 208.

In various embodiments, the process 800 can be performed repeatedly such that, for example, the connection initiator constantly looks to establish and manage new connections. In other embodiments, the process 800 can be performed at certain intervals (e.g., every ten minutes). In still other embodiments, the process 800 can be performed responsive to new or updated information such as, for example, responsive to new or updated registration information from a user associated with the connection initiator, new or updated availability information from the user, and/or the like. The process 800 can also be triggered manually by the user or in another suitable manner.

At block 802, the connection initiator selects a desired connection. In various embodiments, the desired connection can be selected from the user's contacts. The selection can include reviewing group information and priority information as described above. In general, the desired connection specifies a set of one or more users with which the user of the connection initiator would like to communicate.

At block 804, the connection initiator determines network locations (e.g., IP addresses) or other contact information of a set of user devices that correspond to the set of one or more users. In some cases, the connection initiator can store network locations, or other contact information, for some or all of the set of user devices in memory thereof. In other cases, the connection initiator can obtain some or all of the network locations, or other contact information, from the network computer 712.

At block 806, the connection initiator transmits availability information for the desired connection to the set of user devices. The availability information can specify, for example, a duration and time of availability for the user of the connection initiator. In many cases, the availability information may indicate immediate availability. The format of the transmission can be similar, for example, to the format described with respect to the block 610 of FIG. 6.

At block 808, each user device, or a subset, of the set of user devices receives the connection initiator's availability information. At block 810, each user device, or a subset, of the set of user devices identifies any availability overlap of its respective user with the connection initiator's availability information. The block 810 can include, for example, each user device, or a subset, reviewing priority information and group information related to its respective user. It is possible that some of the user devices of the set of user devices do not receive the connection initiator's availability information due, for example, to being powered off, having no connection to a suitable network, or being in an airplane type mode.

At block 812, each user device, or a subset, of the set of user devices transmits availability information to the connection initiator. In general, the availability information from the user devices identifies an availability overlap, if one exists. In some cases, the availability information from the set of user devices can identify more than one period of availability. In other cases, the availability information from the set of user devices may simply indicate whether immediate availability exists (i.e., for an immediate call) and a duration of such availability.

At block 814, the connection initiator receives the availability information from all or a subset of the user devices of the set of user devices. At decision block 816, the connection initiator determines whether a connection is possible. In certain embodiments, a connection can be determined to be possible if an availability overlap exists that overlaps the availability information of the connection initiator and the availability information of one or more of the user devices of the set of user devices. The connection initiator generally will identify a selected availability overlap between the connection initiator and one of possibly several user devices of the set of user devices having an availability overlap with the connection initiator. It is possible though that the connection initiator could identify a selected availability overlap that includes more than one user device of the set of user devices. The connection initiator would establish a multi-party connection in the latter circumstance. In such cases, the multi-party connection is illustrative of a conference connection that can be established in a peer-to-peer fashion.

If it is determined at the decision block 816 that a connection is not possible, the process 800 proceeds to decision block 818. At decision block 818, the connection initiator determines whether there are other desired connections for the connection initiator through which the process 800 has not iterated. If so, the process 800 can return to block 802 for selection of another desired connection. Otherwise, the process 800 proceeds to block 822 and ends.

If it is determined at the decision block 816 that a connection is possible, the process 800 proceeds to block 820. At block 820, the connection initiator facilitates establishment and management of the connection as described, for example, with respect to blocks 614-622 of FIG. 6. At block 822, the process 800 ends. In various embodiments, the blocks 802-822 are preformed automatically (i.e. without user intervention) by the user devices to minimize disturbing the respective users. In some embodiments, one of the user devices of the set of user devices having availability overlap with the connection initiator may proactively initiate the establishment of connection with the connector initiator device. Under this scenario, the connector initiator device may accept the connection or pursue its own process for selecting and connecting with a particular user device from the set.

Various examples of operational scenarios will now be described with reference to Table 1 below. For illustrative purposes, the example operational scenarios are described relative to conference connections established by the communications system 200 in the manner described with respect to FIG. 3C. However, it should be appreciated that the example operational scenarios can also be implemented in other fashions as described, for example, with respect to FIGS. 6-8. In particular, Table 1 illustrates registered contacts for users Tony, Derek, and Harvey.

TABLE 1

| User | Registered Contacts |
|---|---|
| Tony | Derek, Gisela, and Harvey |
| Derek | Brad, Jason, and Tony |
| Harvey | Shuji, Tony, and Daniel |

Example Operational Scenario No. 1:

On Friday at 1:00 pm, Tony utilizes his mobile phone to change his status on the communications system 200 to “available for one hour.” At 1:30 PM, Harvey utilizes his mobile phone to change his status to “available for 20 minutes.” The communications system 200 automatically identifies the overlap between the two contacts, Tony and Harvey, and automatically establishes a conference connection (without further intervention from Tony or Harvey) between Tony and Harvey for twenty minutes. When Tony and Harvey answer their mobile phones, they each hear that a connection has been made with the other and the duration of the call. Towards the end of the twenty-minute duration, the communications system 200 alerts both parties that only two minutes remain. At the end of the twenty-minute duration, the conference connection is automatically disconnected. Neither Tony nor Harvey had to prearrange a call. In this manner, the communications system 200 can automatically maximize availability opportunities between contacts and facilitate a conference connection that stays within an availability window of the parties.

Example Operational Scenario No. 2:

On Monday at 7:00 pm, Harvey changes his status to “available for two hours.” At 7:10 pm, Derek changes his status to “available for one hour.” Note that Harvey and Derek are not listed in each other's registered contacts. Consequently, no phone call is established for them. At 8:00 pm, Tony changes his status to “available for one hour.” Tony is listed in both Harvey and Derek's registered contacts and both Harvey and Derek are listed in Tony's registered contacts.

If Tony and Derek have each identified the other as a prioritized contact, the communications system 200 could establish a call between Tony and Derek (assuming for now that Harvey is not a prioritized contact for Tony). The phone call could be for ten minutes only in order to conform to Derek's availability. At the end of the ten-minute period, the phone call can be terminated. At that time, the communications system 200 can connect Tony and Harvey for a fifty-minute call. If Tony and Derek have not listed each other as prioritized contacts, the communications system 200 could connect Tony and Harvey for one hour to conform to Tony's availability (which is shorter than Harvey's).

Alternatively, the communications system 200 can look for opportunities to allow maximum connection opportunities. Under this option, the communications system 200 could connect Tony and Derek first and then Tony and Harvey. Doing so could allow for three registered users to connect with contacts versus just two registered users. In some embodiments, the communications system 200 can have a default connection time (e.g. five or ten minutes) when looking for availability overlaps. In these embodiments, any time shorter than the default connection time can be treated as if no availability exists. In some cases, the default connection can be useful when attempting maximize connection opportunities.

In certain embodiments, a selected availability overlap may be based on priority scoring logic, as may be appreciated from the following operational scenario:

Example Operational Scenario No. 3:

On Monday at 7:00 pm, Harvey changes his status to “available for two hours.” At 7:10 pm, Derek changes his status to “available for one hour.” Harvey and Derek are not listed in each other's contact list. Consequently, for purposes of this example, no phone call is established for them. At 8:00 pm Tony changes his status to “available for one hour.” Tony is listed in both Harvey and Derek's registered contacts and both Harvey and Derek are listed in Tony's registered contacts. According to this example, each of Tony, Harvey, and Derek have prioritized their contacts as shown below in Table 2.

TABLE 2

| User | Prioritized Contacts |
|---|---|
| Tony | (1) Derek |
| | (2) Gisela |
| | (3) Harvey |
| Derek | (1) Brad |
| | (2) Jason |
| | (3) Tony |
| Harvey | (1) Shuji |
| | (2) Tony |
| | (3) Daniel |

For purposes of this example, the communications system 200) can first score each potential connection by adding the priority positions of each potential connection. For the Tony/Derek connection, the priority score is four (i.e., (1)+(3)=(4)). The Tony/Harvey connection has a priority score of five (i.e., (3)+(2)=(5)). Since the Tony/Derek connection has a lower priority score (meaning a better priority match), the communications system 200 can first connect Tony and Derek. If there is a tie in priority score, the communications system 200 can default to other criteria such as, for example, looking for opportunities to allow the maximum connection opportunities, random selection, even distribution among contacts, etc. For purposes of this example, maximizing connection opportunities would still result in Tony and Derek being connected first.

It should be appreciated that similar principles are applicable even when there are large numbers of potential connections. In a typical embodiment, there will generally be a subset of potential connections that have the best score. If the subset only includes one potential connection, that potential connection can be established. However, in the case of a tie (i.e., the subset includes more than one potential connection), other criteria can be used such as, for example, looking for opportunities to allow the maximum connection opportunities within the subset, random selection, even distribution among contacts, etc.

In some embodiments, priority ratings have to be bilateral to receive consideration. For example, if only one user has the other user as a high priority contact, there will be no priority in the connection because it would create a de facto priority for the other user. In some cases, the system first may confirm the priority of both users. If a priority exists, the priority is acknowledged. Otherwise, the system selects contacts based on other features (e.g. random, or frequency of last contact so that phone calls are distributed evenly within a user's contact list).

In certain embodiments, a selected availability overlap may be based on deduced and user-indicated personality compatibilities, as may be appreciated from the following operational scenario:

Example Operational Scenario No. 4:

As described above, registration information for particular users can include profile information such as, for example, the profile information 248 of FIG. 2. Also as described above, the profile information can include dating-relevant information such as answers to certain compatibility questions. In certain embodiments, the communications system 200 can use dating-compatibility criteria as additional criteria to determine which registered users to connect from respective “dating” groups configured by the registered users. The dating-compatibility criteria can be based, at least in part, on similar answers to the compatibility questions. In various embodiments, the dating-compatibility criteria can be applied at the time of identifying a selected availability overlap as described above.

In certain embodiments, conversation-guidance features such as those described with respect to FIG. 5 can be tailored to the dating context to provide a dating dialogue. For example, a conversation can begin with introductions that may be, for example, a first few minutes of an applicable duration (e.g., five minutes). Afterwards, dating-relevant questions from one or more topics can be presented and monitored as described with respect to FIG. 5. Additionally, at the end of each such dating dialogue, each participating registered user may be permitted to rate the dialogue and/or the other participating registered user (e.g., on a scale of one to five). In certain embodiments, a rating of lower than a threshold value from either participating registered user (e.g., lower than two on a scale of one to five) can prevent further connections between them. In certain embodiments, ratings of higher than a threshold value (e.g., higher than three on a scale of one to five) from one or both participating registered users can result in future connections between them. In some embodiments, such higher ratings can be treated in a manner akin to priorities as described above.

Other variations can also be implemented to suit the dating context. For example, the contact information for each registered user may be kept private. By way of further example, monitoring can occur for inappropriate or obscene language. Upon detection of inappropriate or obscene language, an offending registered user can be presented a warning that the conversation will be terminated, etc. In some embodiments, a non-offending registered user can be prompted to choose whether the conversation should continue. In these embodiments, the conversation can continue or be terminated in accordance with a choice received from the non-offending registered user.

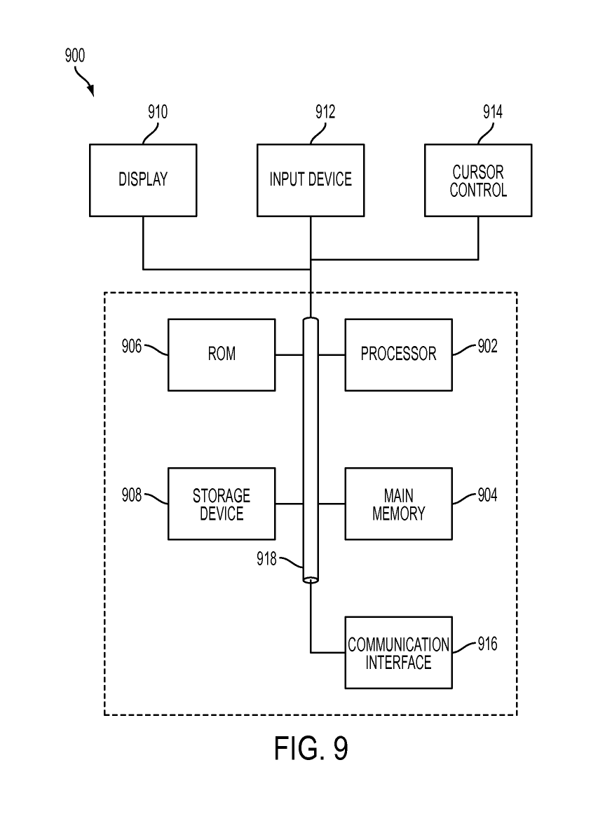

FIG. 9 illustrates an embodiment of a computer system 900 on which various computers or systems described herein can be implemented. For example, the computer system 900 can be illustrative of each of the user devices 208, the controller 212, the registrar 216, and/or the connection subsystem 220. The computer system 900 may be, for example, similar to the at least one server computer 226, the at least one server computer 230, and/or the at least one server computer 234, respectively, of FIG. 1.

The computer system 900 may be a physical system, virtual system, or a combination of both physical and virtual systems. In the implementation, a computer system 900 may include a bus 918 or other communication mechanism for communicating information and one or more processors 902 coupled to the bus 918 for processing information. The computer system 900 also includes multiple memory modules. There is a main memory 904, such as random-access memory (RAM) or other dynamic storage device, coupled to the bus 918 for storing computer readable instructions by the one or more processors 902.

The main memory 904 also may be used for storing temporary variables or other intermediate information during execution of the instructions to be executed by the one or more processors 902. The computer system 900 further includes a read-only memory (ROM) 906 or other static storage device coupled to the bus 918 for storing static information and instructions for the one or more processors 902. A computer-readable storage device 908, such as a solid state drive, magnetic disk or optical disk, is coupled to the bus 918 for storing information and instructions for the one or more processors 902. The computer system 900 may be coupled via the bus 918 to a display 910, such as a liquid crystal display (LCD) or a cathode ray tube (CRT), for displaying information to a user. An input device 912, including, for example, alphanumeric and other keys, is coupled to the bus 918 for communicating information and command selections to the one or more processors 902. Another type of user input device is a cursor control 914, such as a mouse, a trackball, or cursor direction keys for communicating direct information and command selections to the processor 902 and for controlling cursor movement on the display 910. The cursor control 914 typically has two degrees of freedom in two axes, a first axis (e.g., x) and a second axis (e.g., y), that allow the device to specify positions in a plane. The input device can also be part of the display 910 such as a touch screen.

The term “computer readable instructions” as used above refers to any instructions that may be performed by the one or more processors 902 and/or other component of the computer system 900. Similarly, the term “computer readable medium” refers to any non-transitory storage medium that may be used to store the computer readable instructions (i.e. software or computer program). Such a medium may take many forms, including, but not limited to, nonvolatile media, and volatile media. Non-volatile media include, for example, optical or magnetic disks, such as the storage device 908. Volatile media includes dynamic memory, such as the main memory 904. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EPROM, any other memory chip or cartridge, or any other medium from which a computer can read.

Various forms of the computer readable media may be involved in carrying one or more sequences of one or more instructions to the one or more processors 902 for execution. For example, the instructions may initially be borne on a magnetic disk of a remote computer. The remote computer can load the instructions into its dynamic memory and send the instructions over a telephone line using a modem. A modem local to the computer system 900 can receive the data on the telephone line and use an infrared transmitter to convert the data to an infrared signal. An infrared detector coupled to the bus 918 can receive the data carried in the infrared signal and place the data on the bus 918. The bus 918 carries the data to the main memory 904, from which the one or more processors 902 retrieves and executes the instructions. The instructions received by the main memory 904 may optionally be stored on the storage device 908 either before or after execution by the one or more processors 902.

The computer system 900 may also include a communication interface 916 coupled to the bus 918. The communication interface 916 provides a two-way data communication coupling between the computer system 900 and a network. For example, the communication interface 916 may be an integrated services digital network (ISDN) card or a modem used to provide a data communication connection to a corresponding type of telephone line. As another example, the communication interface 916 may be a local area network (LAN) card used to provide a data communication connection to a compatible LAN. Wireless links may also be implemented. In any such implementation, the communication interface 916 sends, via one or more transmitters, and receives, via one or more receivers, electrical, electromagnetic, optical, or other signals that carry digital data streams representing various types of information. The storage device 908 can further include instructions for carrying out various processes for image processing as described herein when executed by the one or more processors 902. The storage device 908 can further include a database for storing data relative to same.

Any suitable combination of various embodiments, or the features thereof, is contemplated. For example, any steps or blocks disclosed in a process herein may be used in other processes described herein. Thus, a block of one of the processes described in FIGS. 3A-6 and 8 may be used in any of the processes described in these Figures.

In a typical embodiment, a method comprises receiving availability information of a first user, transmitting, through a communication network, the availability information of the first user to one or more devices associated with one or more users identified as one or more desired communication contacts of the first user, receiving availability information for at least a portion of the one or more users from the one or more devices associated with the one or more users, identifying, based at least on a portion of the received availability information, an availability overlap between the first user and a second user, wherein the second user has identified the first user as a desired communication contact, initiating establishment of a connection between a device of the first user and a device of the second user, and wherein the transmitting of the availability information of the first user, the receiving of the availability information for at least a portion of the one or more users, the identifying of the availability overlap between the first user and the second user, and the initiating of the establishment of the connection are performed automatically subsequent to receiving the availability information of the first user. The method further comprises identifying a duration of availability overlap between the first and second users, notifying the first and second users that the duration of availability overlap is ending, and initiating termination of the connection at the end of the duration of availability overlap, wherein the initiation of termination is performed automatically.

In a typical embodiment, the method further comprises in response to initiating the termination of the connection between the device of the first user and the device of the second user, identifying an availability overlap between the first user and a third user, wherein the first and third users have identified each other as desired communication contacts, initiating establishment of a connection between the device of the first user and a device of the third user, wherein the initiation is performed automatically subsequent to receiving availability information of the first user, identifying, based at least on a portion of the received availability information, an availability overlap between the first user and multiple other users, wherein the first user and the multiple other users are identified as desired communication contacts, selecting the first and second users for a connection, and receiving group selection information of the first user, wherein the one or more users are associated with the group.

In a typical embodiment, identifying the availability overlap further comprises reviewing priority indications associated with the one or more users in addition to the received availability information, wherein at least one of short message service and multimedia messaging service are utilized for transmitting the availability information of the first user, and wherein at least one of short message service and multimedia messaging service are utilized for receiving the availability information for the at least a portion of the one or more users.

In a typical embodiment, the method further comprises providing a first suggested conversation topic to the first and second users during the connection, monitoring the connection for a period of silence, providing a second suggested conversation topic in response to a detection of the period of silence, wherein availability information includes a start time and an end time, and wherein availability information includes at least one of a duration and an end time.

In a typical embodiment, the method further comprises requesting contact information for the one or more users from a server device, receiving the contact information, wherein the received contact information is utilized in transmitting the availability information of the first user, and wherein the received contact information includes an internet protocol address.

In a typical embodiment, the method further comprises receiving a prolong indication from the first or second user, in response to the received prolong indication, maintaining the connection between the device of the first user and the device of the second user, identifying, based at least on a portion of the received availability information, an availability overlap between the first user, the second user, and a third user, wherein the first, second, and third users have identified each other as desired communication contacts, initiating establishment of a second connection to a device of the third user, initiating establishment of a conference connection including the connection and the second connection, wherein the connection utilizes at least one of cellular network protocols and voice over internet protocols, and wherein the first and second users have identified each other as desired communication contacts via a registration process.

In a typical embodiment, a method comprises receiving availability information of a first user on a first device associated with the first user, receiving availability information for a second user from a second device associated with the second user, identifying, based at least on a portion of the received availability information, an availability overlap between the first user and a second user, wherein the first and second users have identified each other as desired communication contacts, transmitting, via the first device, availability information of the first user to the second device through a communication network, and wherein the receiving availability information for the second user, identifying an availability overlap, and transmitting availability information are performed automatically subsequent to receiving availability information of the first user.

In a typical embodiment, the method further comprises initiating establishment of a connection between the first device and the second device, identifying a duration of availability overlap between the first and second users, notifying the first and second users that the duration of availability overlap is ending, and initiating termination of the connection at the end of the duration of availability overlap, wherein the initiation of termination is performed automatically.

In a typical embodiment, the method further comprises receiving location information of the first user, receiving location information of the second user, and reviewing the location information of the first and second users in addition to the received availability information of the first and second users when identifying the availability overlap between the first user and the second user.

In a typical embodiment, the method further comprises receiving group selection information of the first user, reviewing the group selection information in addition to the received availability information of the first and second users when identifying the availability overlap between the first user and the second user, wherein identifying the availability overlap further comprises reviewing a priority indication associated with the second user in addition to the received availability information of the first and second users, wherein at least one of short message service and multimedia messaging service are utilized for transmitting the availability information of the first user, and wherein at least one of short message service and multimedia messaging service are utilized for receiving the availability information for the second user.

In a typical embodiment, the method further comprises providing a first suggested conversation topic to the first and second users during the connection, monitoring the connection for a period of silence, providing a second suggested conversation topic in response to a detection of the period of silence, wherein availability information includes a start time and an end time, and wherein availability information includes at least one of a duration and an end time.

In a typical embodiment, the method further comprises receiving a prolong indication from the first or second user, in response to the received prolong indication, maintaining the connection, identifying, based at least on a portion of the received availability information, an availability overlap between the first user, the second user, and a third user, wherein the first, second, and third users have identified each other as desired communication contacts, initiating establishment of a second connection to a device of the third user, initiating establishment of a conference connection including the connection and the second connection, wherein the connection utilizes at least one of cellular network protocols and voice over internet protocols, and wherein the first and second users have identified each other as desired communication contacts via a registration process.

In a typical embodiment, a method comprises receiving availability information for one or more users from one or more devices associated with the one or more users, identifying, based at least on a portion of the received availability information, an availability overlap between a first user and a second user, wherein the first and second users have identified each other as desired communication contacts, initiating establishment of a first connection to a device of the first user, initiating establishment of a second connection to a device of the second user, initiating establishment of a conference connection including the first and second connections, identifying a duration of availability overlap between the first and second users, notifying the first and second users that the duration of availability overlap is ending, and initiating termination of the conference connection at the end of the duration of availability overlap.

In a typical embodiment, the method further comprises in response to initiating the termination of the conference connection including the first and second connections, identifying an availability overlap between the first user and a third user, wherein the first and third users have identified each other as desired communication contacts, initiating establishment of a third connection to a device of the third user, and initiating establishment of a conference connection including the first and third connections.

In a typical embodiment, the method further comprises identifying, based at least on a portion of the received availability information, an availability overlap between the first user and multiple other users, wherein the first user and the multiple other users are identified as desired communication contacts, and selecting the first and second users for a conference connection.

In a typical embodiment, the method further comprises receiving group selection information for the one or more users from the one or more devices associated with the one or more users, reviewing the group selection information in addition to the received availability information when identifying the availability overlap between the first user and the second user, and wherein the identifying the availability overlap further comprises reviewing priority indications associated with the one or more users in addition to the received availability information.

In a typical embodiment, the method further comprises transmitting contact information of the first and second users to a device, wherein the device utilizes the contact information of the first and second users to initiate the establishment of the first and second connections as well as initiating the establishment of the conference connection, providing a first suggested conversation topic to the first and second users during the conference connection, monitoring the conference connection for a period of silence, providing a second suggested conversation topic in response to a detection of the period of silence, wherein the received availability information includes a start time and an end time, and wherein the received availability information includes at least one of a duration and an end time.

In a typical embodiment, the method further comprises receiving updated availability information for the first user from the device of the first user, the updated availability information indicating a period of time that the first user is temporarily unavailable for a connection, and delaying the establishment of the first and second connections until the period of time has expired.

In a typical embodiment, the method further comprises determining the device of the first user is more difficult to establish a connection to than the device of the second user and based on the determination, initiating the establishment of the first connection to the device of the first user before initiating the establishment of the second connection to the device of the second user.

In a typical embodiment, the method further comprises receiving a prolong indication from the first or second user and in response to the received prolong indication, maintaining the conference connection.

In a typical embodiment, the method further comprises identifying, based at least on a portion of the received availability information, an availability overlap between the first user, the second user, and a third user, wherein the first, second, and third users have identified each other as desired communication contacts, initiating establishment of a third connection to a device of the third user, expanding the conference connection to include the third connection, wherein the first and second connections utilize at least one of cellular network protocols and voice over internet protocols, and wherein the first and second users have identified each other as desired communication contacts via a registration process.

In a typical embodiment, a method comprises receiving availability information for one or more users from one or more devices associated with the one or more users, identifying, based at least on a portion of the received availability information, an availability overlap between a first user and a second user, wherein the first and second users have identified each other as desired communication contacts, in response to identifying the availability overlap between the first user and the second user, transmitting contact information of the second user to a device of the first user, wherein the device of the first user can utilize the contact information of the second user to initiate establishment of a connection between a device of the second user and the device of the first user, identifying a duration of availability overlap between the first and second users, transmitting the duration of availability overlap to the device of the first user, and wherein the contact information includes at least one of a phone number and an internet protocol address of the device of the second user.

In a typical embodiment, the method further comprises notifying the first user that the duration of availability overlap is ending, identifying, based at least on a portion of the received availability information, an availability overlap among the first user and multiple other users, wherein the first user and the multiple other users are identified as desired communication contacts, and selecting the first and second users for a connection.

In a typical embodiment, the method further comprises receiving group selection information for the one or more users from the one or more devices associated with the one or more users, reviewing the group selection information in addition to the received availability information when identifying the availability overlap between the first user and the second user, and wherein the identifying the availability overlap further comprises reviewing priority indications associated with the one or more users in addition to the received availability information.

In a typical embodiment, the method further comprises providing a first suggested conversation topic to the first user, wherein the received availability information includes a start time and an end time, and wherein the received availability information includes at least one of a duration and an end time.

In a typical embodiment, the method further comprises receiving updated availability information for the first user from the device of the first user, the updated availability information indicating a period of time that the first user is temporarily unavailable for a connection, delaying the transmission of contact information of the second user to the device of the first user until the period of time has expired, and identifying the availability overlap further comprises reviewing connection history establishment information associated with the one or more users in addition to the received availability information.

In a typical embodiment, the method further comprises identifying, based at least on a portion of the received availability information, an availability overlap between the first user, the second user, and a third user, wherein the first, second, and third users have identified each other as desired communication contacts, transmitting contact information of the third user to the device of the first user, wherein the device of the first user can utilize the contact information of the second user and third user to initiate establishment of a conference connection including the device of the second user, the device of the first user, and a device of the third user, wherein at least one of short message service and multimedia messaging service are utilized for transmitting contact information of the second user to the device of the first user, and wherein the first and second users have identified each other as desired communication contacts via a registration process.

Although various embodiments of the disclosed method and apparatus have been illustrated in the accompanying Drawings and described in the foregoing Detailed Description, it will be understood that the method and apparatus is not limited to the embodiments disclosed, but is capable of numerous rearrangements, modifications and substitutions without departing from the spirit of the disclosure as set forth herein.

What is claimed is:

1. A method comprising:
receiving availability information of a first user;
transmitting the availability information of the first user to a device through a communication network;
receiving, from the device, contact information of a second user having availability overlap with the first user, wherein the first and second users have identified each other as desired communication contacts;
initiating, based at least on a portion of the received contact information, establishment of a connection between a device of the first user and a device of the second user; and
wherein the transmitting of the availability information of the first user, the receiving of the contact information of the second user, and the initiating of the establishment of the connection are performed automatically subsequent to receiving availability information of the first user.

2. The method of claim 1, wherein the contact information includes at least one of a phone number and an internet protocol address of the device of the second user.

3. The method of claim 1, further comprising:
receiving, from the device, a duration of availability overlap between the first and second users.

4. The method of claim 3, further comprising:
notifying the first and second users that the duration of availability overlap is ending.

5. The method of claim 3, further comprising:
initiating termination of the connection at the end of the duration of availability overlap, wherein the initiation of termination is performed automatically.

6. The method of claim 1, further comprising:
receiving group selection information of the first user; and
transmitting the group selection information of the first user to the device.

7. The method of claim 1, further comprising:
receiving priority indication information of the first user; and
transmitting the priority indication information of the first user to the device.

8. The method of claim 1, further comprising:
providing a first suggested conversation topic to the first and second users during the connection.

9. The method of claim 8, further comprising:
monitoring the connection for a period of silence; and
providing a second suggested conversation topic in response to a detection of the period of silence.

10. The method of claim 1, wherein the received availability information includes a start time and an end time.

11. The method of claim 1, wherein the received availability information includes at least one of a duration and an end time.

12. The method of claim 1, further comprising:
receiving, from the device, contact information of a third user having availability overlap with the first user, wherein the first, second, and third users have identified each other as desired communication contacts;
initiating establishment of a connection between the device of the first user and a device of the third user; and
initiating establishment of a conference connection including the first, second, and third users.

13. The method of claim 1, wherein at least one of short message service and multimedia messaging service are utilized for receiving, from the device, contact information of the second user.

14. The method of claim 1, wherein the received contact information includes an internet protocol address.

15. The method of claim 4, further comprising:
receiving a prolong indication from the first or second user; and
in response to the received prolong indication, maintaining the connection between the device of the first user and the device of the second user.

16. The method of claim 1, wherein the first and second users have identified each other as desired communication contacts via a registration process.
